(19) United States
(12) Patent Application Publication
(10) Pub. No.: US 2007/0268446 A1
(43) Pub. Date: Nov. 22, 2007

(54) Liquid crystal device and method for forming the same

(76) Inventors: Shie-Chang Jeng, Ligang Township (TW); Lung-Pin Hsin, Jhudong Township (TW); Yan-Rung Lin, Wondan Township (TW); Chi-Chang Liao, Tainan City (TW)

Correspondence Address: J.C. Patents, Inc.;Suite 250, 4 Venture, Irvine, CA, 92618, US

(21) Appl. No.: 11/439,476

(22) Filed: May 22, 2006

(51) Int. Cl. C09K 19/52

(52) U.S. Cl. 349/166

(57) ABSTRACT

The present invention generally relates to liquid crystal devices and methods for forming the same. More particularly, the present invention relates to liquid crystal devices easy to be fabricated. Such liquid crystal devices exhibit excellent display characteristics such as a high contrast with a simple structure. The liquid crystal liquid crystal device includes a plurality of encapsulated liquid crystal composite filled in between substrates. In particular, the liquid crystal composite comprises liquid crystal molecules and fine-particles, and is optically isotropic when the voltage applied to the electrode layer is lower than a threshold value and undergoes optical transition due to change in the arrangement of the liquid crystal molecules when the applied voltage is equal to or higher than the threshold value.

### BACKGROUND OF THE INVENTION

1. Field of the Invention

The present invention generally relates to liquid crystal devices and methods for forming the same. More particularly, the present invention relates to liquid crystal devices easy to be fabricated. Such liquid crystal devices can be applied to form an excellent display with a high contrast with a simple structure.

2. Description of Related Art

To fabricate a conventional liquid crystal display (LCD) panel, liquid crystal molecules are filled by vacuum filling and are sealed to form a liquid crystal cell comprising two sheets of transparent conductive substrates having an alignment layer applied thereto and a sealing layer provided between the substrates. The cell is difficult to manufacture due to the complicate structure and process which in turn increase the cost. Several methods have been proposed and implemented to reduce the manufacture process by encapsulating display media, such as by polymer dispersed method, microcup, phase separation and tubing. These methods not only reduce the manufacture process and also can be adopted by roll-to-roll process especially for flexible device. Polymer dispersed liquid crystal could be implemented by emulsion and phase separation (U.S. Pat. Nos. 5,835,174, 5,976,405, 6,037,058, 6,108,062). Microcup structure has been utilized in liquid crystal display and electrophoretic display (U.S. Pat. Nos. 6,795,138, 6,833,943, 6,859,302). Phase separation method has been implemented to produce a single substrate liquid crystal display (WO 0242832, U.S. Pat. No. 6,818,152), and it is especially useful for flexible optical device due to its light weight. Electrophoretic particles insulated by tubing are also shown in U.S. Pat. No. 6,876,476. Although all of the above encapsulated methods are promising to obtain a cost effective manufacture method, they can not be used to fabricate a high quality display device due to no alignment layer can be applied on the encapsulating walls.

### SUMMARY OF THE INVENTION

Accordingly, the present invention is directed to a liquid crystal device and method for forming the same that is easy to manufacture by roll-to-roll compatible process and having good contrast ratio and displaying quality without requiring alignment layers.

The present invention provides a liquid crystal device. The liquid crystal device comprises a substrate having an electrode layer and a plurality of micro-cups thereon, a liquid crystal composite filled in the micro-cups and a covering component having a counter electrode thereon over the micro-cups. In particular, the liquid crystal composite comprises liquid crystal molecules and fine-particles, and is optically isotropic when the voltage applied to the electrode layer is lower than a threshold value and undergoes optical transition due to change in the arrangement of the liquid crystal molecules when the applied voltage is equal to or higher than the threshold value.

The present invention also provides a liquid crystal device comprising a liquid crystal composite, a substrate and a covering layer. The covering layer-encapsulated liquid crystal composite is produced by photo-induced polymerization or photo-induced phase separation. In particular, the liquid crystal composite comprises liquid crystal molecules and fine-particles, and is optically isotropic when a voltage applied to the electrode layer is lower than a threshold value and undergoes optical transition due to change in an arrangement of the liquid crystal molecules when the applied voltage is equal to or higher than the threshold value. The substrate has an electrode layer thereon and is disposed at a side of the liquid crystal composite and confining the liquid crystal composite. The covering layer has a counter electrode thereon is disposed adjacent to the liquid crystal composite for covering the liquid crystal composite at a side opposite to the substrate.

The present invention also provides a liquid crystal device comprising a first substrate, a second substrate, a plurality of droplets of liquid crystal composite. The first substrate has an electrode layer thereon. The second substrate has a counter electrode thereon is disposed opposite to the first substrate. A method for producing the droplets of liquid crystal composite includes the steps of dispersing liquid crystal molecules and fine-particles in a dispersion medium composed mainly of water to prepare an oil-in-water type emulsion. The liquid crystal composite is optically isotropic when a voltage applied to the electrode layer is lower than a threshold value and undergoes optical transition due to change in an arrangement of the liquid crystal molecules when the applied voltage is equal to or higher than the threshold value.

The present invention also provides a liquid crystal device comprising a first substrate, a second substrate, a plurality of tubes and a liquid crystal composite. The first substrate has an electrode layer thereon. The second substrate having a counter electrode layer thereon is disposed opposite to the first substrate. The tubes are disposed parallel to each other between the first and second substrates. The liquid crystal composite is filled in the tubes, wherein the liquid crystal composite comprises liquid crystal molecules and fine-particles, and is optically isotropic when a voltage applied to the electrode layer is lower than a threshold value and undergoes optical transition due to change in an arrangement of the liquid crystal molecules when the applied voltage is equal to or higher than the threshold value.

According to an embodiment of the present invention, the fine-particles have an average particle diameter of not more than 0.2 μm.

According to an embodiment of the present invention, the fine-particles comprises conductive fine-particles.

According to an embodiment of the present invention, the liquid crystal device further comprises a plurality of protrusions over the substrate.

According to an embodiment of the present invention, the substrate has a plurality of micro-cavities therein.

The present invention also provide a method of forming a liquid crystal device. The method includes providing a substrate having an electrode layer thereon; forming a liquid crystal composite over the substrate, wherein the liquid crystal composite comprises liquid crystal molecules and fine-particles, and is optically isotropic when a voltage applied to the electrode layer is lower than a threshold value and undergoes optical transition due to change in an arrangement of the liquid crystal molecules when the applied voltage is equal to or higher than the threshold value; and forming a covering component over the liquid crystal composite. In particular, the steps of providing the substrate, forming the liquid crystal composite and forming the covering component are performed with a roll-to-roll continuous process.

According to an embodiment of the present invention, the method further comprising forming a plurality micro-cups on the substrate before the liquid crystal composite is formed on the substrate.

According to an embodiment of the present invention, the steps of forming the liquid crystal composite and the covering component comprising forming a composition film including the liquid crystal composite and at least a monomer over the substrate; and performing an exposure step to the composition film so that a polymerization selectivity occurs, and then a polymer layer that is not miscible with the liquid crystal composite is formed on the top of the liquid crystal composite.

According to an embodiment of the present invention, the step of forming the liquid crystal composite comprising forming a plurality of droplets with the liquid crystal composite encapsulated therein; and coating the droplets with the liquid crystal composite over the substrate.

According to an embodiment of the present invention, the step of forming the liquid crystal composite comprising forming a plurality of tubes with the liquid crystal composite therein; and arranging the tubes with the liquid crystal composite over the substrate.

According to an embodiment of the present invention, the method further comprising forming a plurality of protrusions over the substrate before the liquid crystal composite is formed over the substrate.

According to an embodiment of the present invention, the method further comprising forming a plurality of micro-cavities in the substrate before the liquid crystal composite is formed over the substrate.

According to an embodiment of the present invention, the fine-particles comprise conductive fine-particles.

The liquid crystal composite of the liquid crystal device of the present invention comprises liquid crystal molecules and fine-particles, and the liquid crystal composite is optically isotropic when the voltage applied to the electrode layer is lower than a threshold value and undergoes optical transition due to change in the arrangement of the liquid crystal molecules when the applied voltage is equal to or higher than the threshold value. Therefore, the liquid crystal device of the present invention has a better or high contrast ratio and displaying quality without requiring any alignment processes or alignment layers.

The liquid crystal devices of the present invention are easy to manufacture by roll-to-roll compatible process. If the protrusions or micro-cavities are further formed in the liquid crystal devices, the purpose of display application with wide viewing angle can easily be achieved. In particular, the step of forming protrusions or micro-cavities can be easily integrated into the roll-to-roll compatible process. On the other hand, if the fine-particles added in the liquid crystal composite are conductive, the liquid crystal device can also achieve wide viewing angle without forming protrusions or micro-cavities.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A-1C are cross-sectional views showing a method of manufacturing a micro-cup liquid crystal liquid crystal device according to an embodiment of the present invention.

FIGS. 2A-2B are cross-sectional views showing micro-cup liquid crystal devices according to several embodiments of the present invention.

FIG. 3A shows the state of the liquid crystal composite when the voltage applied to the electrode layer is lower than a threshold value.

FIG. 3B shows the state of the liquid crystal composite when the voltage applied to the electrode layer is equal to or higher than the threshold value.

FIG. 4 is a cross-sectional view showing a phase separation liquid crystal device according to an embodiment of the present invention.

FIGS. 5A-5C are cross-sectional views showing a method of fabricating a phase separation liquid crystal device according to an embodiment of the present invention.

FIG. 6 is a cross-sectional view showing a droplet-encapsulated liquid crystal device according to an embodiment of the present invention.

FIG. 7A is diagram showing a tube-encapsulated liquid crystal device according to an embodiment of the present invention. FIG. 7B is a cross-sectional view showing the tube-encapsulated liquid crystal device.

FIGS. 8-10 are cross-sectional views showing the liquid crystal devices having wide viewing angle according to embodiments of the present invention.

FIG. 11 is a diagram showing a continuous roll-to-roll process according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the present invention, the liquid crystal composite including liquid crystal molecules and fine-particles can be applied to various type liquid crystal devices. Several liquid crystal devices are described in the following paragraphs for illustration but not limited the present invention.

### First Embodiment (Micro-Cup LCD Panel)

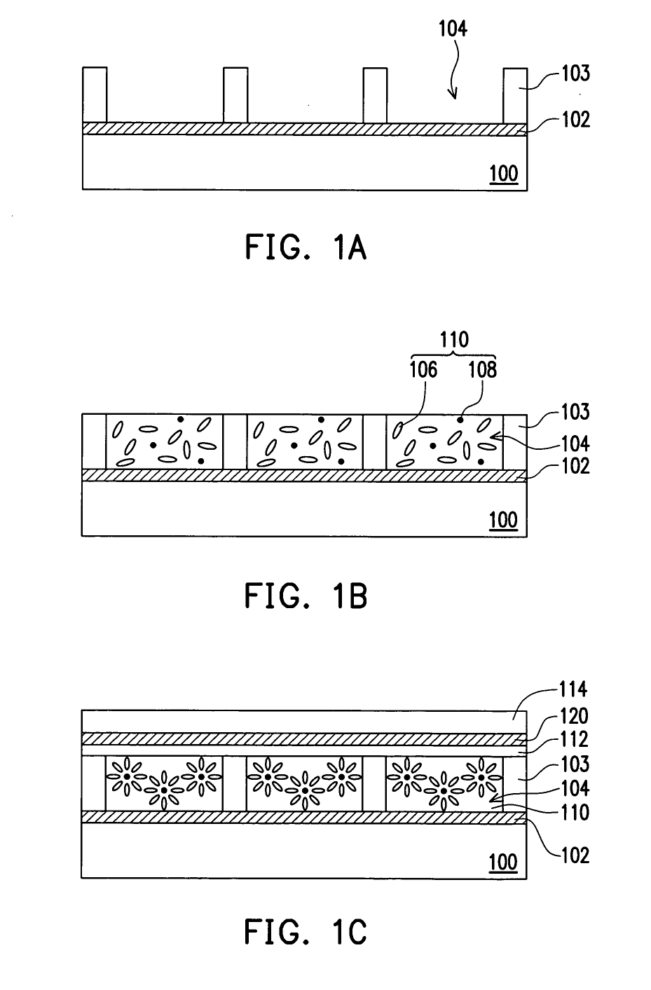

FIGS. 1A-1C are cross-sectional views showing a method of manufacturing a micro-cup liquid crystal device according to an embodiment of the present invention. Please refer to FIG. 1A, a substrate 100 is provided. The substrate 100 is, for example, a flexible substrate such as a plastic substrate. However, the substrate 100 is not particularly restricted, and it can be a rigid substrate, such as a glass substrate. An electrode layer 102 is formed on the substrate 100. The electrode layer 102 shown in the drawing is formed on the top surface of the substrate 100. The electrode layer 102 is made from indium tin oxide (ITO) or indium zinc oxide (IZO), for example. The material of the electrode layer 102 can also be an organic conductive material. According to an embodiment, the layer 102 may further comprise a device array. In details, if the liquid crystal device fabricated by the method of the present invention is an active matrix liquid crystal device, the layer 102 is comprised of a device array and pixel electrodes electrically connecting to the device array. If the liquid crystal device fabricated by the method of the present invention is a passive matrix liquid crystal device, the layer 102 is composed of electrode patterns. After forming the electrode layer 102, a wall structure 103 is formed over the substrate 100 to define several micro-cups 104. The wall structure 103 can be formed by well known photolithography process or molding process.

Thereafter, a liquid crystal composite 110 is filled into the micro-cups 104. In this embodiment, the liquid crystal composite 110 comprises liquid crystal molecules 106 and fine-particles 108. Moreover, it is preferable to disperse the fine-particles 108 in the liquid crystal molecules 106. In an embodiment, the fine-particles 108 have an amount of 1 to 20% by mass relative to the total mass of the fine-particles 108 and liquid crystal molecules 106. More preferable upper limit is 10% by mass and more preferable lower limit is 3% by mass. The liquid crystal composite 110 may contain additives such as an optically active substance, a dichroic dye or the like. The liquid crystal molecules 106 mentioned above are not particularly restricted if they are capable of exhibiting liquid crystallinity, and for example, nematic liquid crystal molecules are preferred. The dielectric anisotropy of the liquid crystal molecules 106 may be positive or negative but the use of liquid crystal molecules with a negative dielectric anisotropy is preferred.

The fine-particles 108 of the liquid crystal composite 110 in the present invention is not particularly restricted, and may be transparent or opaque. The fine-particles 108 may be organic solid particles, inorganic solid particles or the like. The organic solid particles can be made from styrenic or acrylic organic materials. For example, polystyrene beads, poly(methyl methacrylate) beads, poly(hydroxyethyl acrylate) beads or divinylbenzene beads. These may be crosslinked or uncrosslinked. In addition, the inorganic solid particles may be inorganic oxide. For example, silicon dioxide fine-particles or metal oxide fine-particles. Moreover, fine-particles comprising glass, silica, titania, alumina or other inorganic beads can also be preferably used. These fine-particles may be hydrophilic or hydrophobic. According to another embodiment of the present invention, the fine-particles 108 may include fullerene and/or carbon nanotubes. The fullerene mentioned above may be any of those having carbon atoms in a spherical shape. For example, the fullerene may be the one having a stable structure such that the number of carbon atoms is from 24 to 96. As such fullerene, the C60 spherical closed shell carbon molecule consisting of 60 carbon atoms, among others, can be mentioned. As the carbon nano-tube mentioned above, for example, a cylindrical nano-tube which is obtainable by circularizing the graphitic carbon-atom surface of a layer having a thickness of several atoms can be used. Moreover, the fine-particles 108 have an average particle diameter of not more than 0.2 μm. More preferred upper limit is 0.15 μm and more preferred lower limit is 0.001 μm.

After filling the liquid crystal composite 110 into the micro-cups 104, a covering component 114 and an electrode layer 120 are formed over the micro-cups 104 so as to seal the liquid crystal composite 110 in the micro-cups 104, and thus a liquid crystal liquid crystal device is formed as shown in FIG. 1C. In an embodiment, the method of forming the covering component 114 and the electrode layer 120 over the micro-cups 104 comprises forming an electrode layer 120 and a sealant 112 over the micro-cups 104 sequentially, and then laminating the sealed micro-cups 104 with a covering component 114. According to another embodiment of the present invention, the method of forming the covering component 114 and the electrode layer 120 over the micro-cups 104 comprises forming an electrode layer 120 over the covering component 114 and forming a sealant 112 over the micro-cups 104, and then the covering component 114 having the electrode layer 120 thereon is assembled with the micro-cups 104 through the sealant 112. The covering component 114 is not particularly restricted and it may be a protecting thin film or a covering substrate or panel.

In particular, the liquid crystal composite 110 of the liquid crystal device has fine-particles 108 therein. The fine-particles 108 may cause vertical alignment of liquid crystal molecules 106 on the particle surface. The vertical alignment of liquid crystal molecules 106 on the surface of the fine-particles 108 means the alignment of liquid crystal molecules 106 in the long axis direction on the surface of the fine-particles 108 to form a nematic orientation around the fine-particles, as shown in FIG. 1C. In this state, liquid crystal molecules 106 are aligned to surround the fine-particles 108.

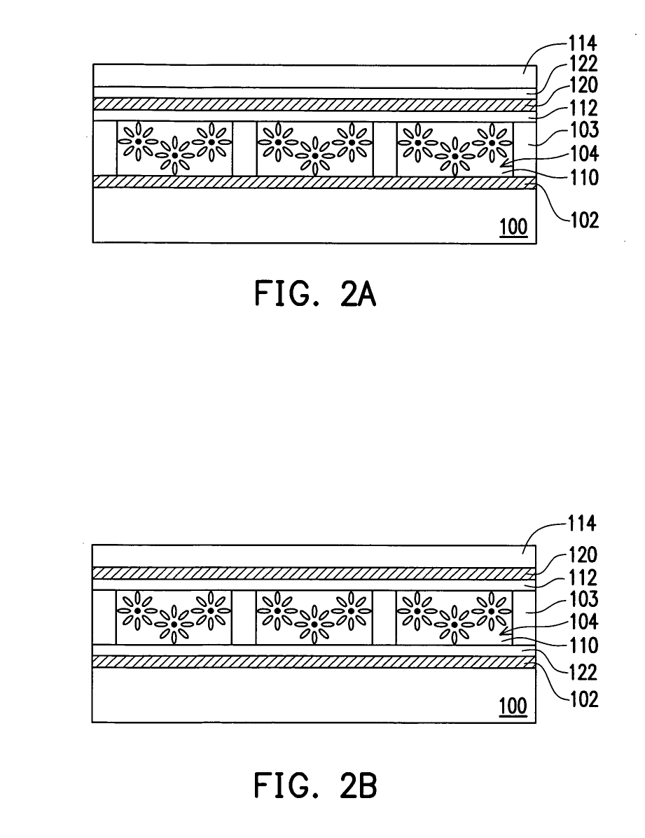

According to other embodiments of the present invention, the micro-cup liquid crystal device may further comprise other film layers. For example, as shown in FIG. 2A, the liquid crystal device further comprises a color filter array 122 between the covering component 114 and the electrode layer 120. According to another embodiment, as shown in FIG. 2B, the color filter array 122 is disposed over the substrate 100, and it may be formed on the electrode layer 102, for example.

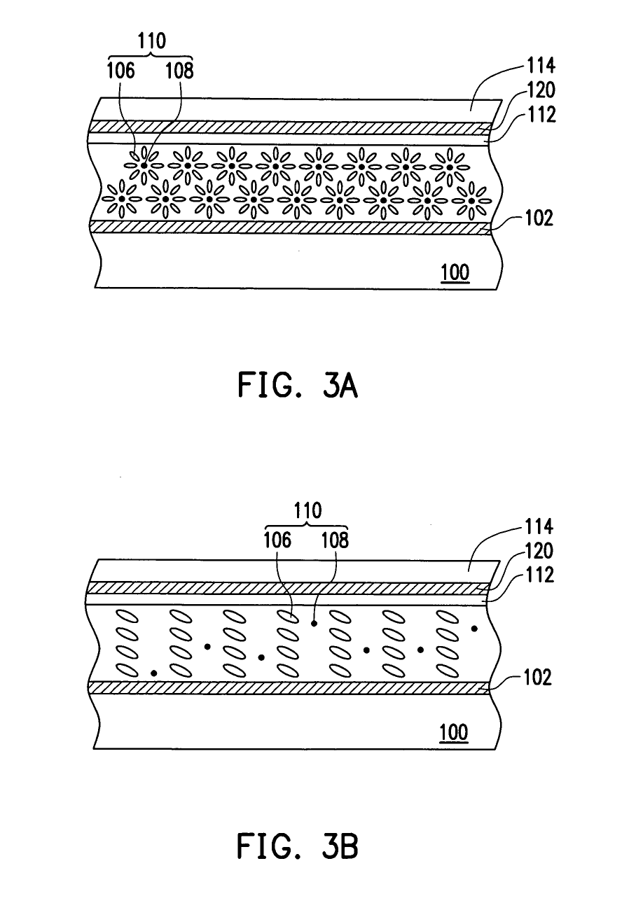

In the micro-cup liquid crystal devices above mentioned, the liquid crystal composite 110 includes liquid crystal molecules 106 and fine-particles 108. The alignment of liquid crystal molecules 106 of the liquid crystal device is explained as follows and shown in FIG. 3A and FIG. 3B. FIG. 3A is a cross-sectional view showing the state of the liquid crystal composite in the liquid crystal device when the voltage applied to the electrode layer 102 is lower than a threshold value. FIG. 3B is a cross-sectional view showing the state of the liquid crystal composite in the liquid crystal device when the voltage applied to the electrode layer 102 is equal to or higher than the threshold value. In the liquid crystal device of the present invention, the liquid crystal molecules 106 are disposed to line up in a certain settled direction when the voltage applied to the electrode is lower than a threshold value. However, because the fine particle 106 has been dispersed in the liquid crystal composite 110 as shown in FIG. 3A, the liquid crystal molecules 106 are rather controlled by the orientation of the surface of fine particle 108. Usually, the surface orientation force of fine-particles 108 has the power to align several liquid crystal molecules 106. Therefore, the liquid crystal molecules 106 are aligned in the manner surrounding the fine-particles 106, with one mass of the molecules being formed per particle. The size of this mass is dependent on the orientation force of the fine particle surface and also on the species of liquid crystal molecules. The size of the mass is not larger than ¼ of the wavelength of visible light.

On the other hand, when the voltage applied to the electrode layer 102 is not lower than the threshold voltage, the liquid crystal molecules 106 are aligned in the same direction as shown in FIG. 3B. In this case, since the liquid crystal molecules 106 are nematic liquid crystal molecules, the liquid crystal molecules 106 in the liquid crystal composite 110 form a nematic phase.

The liquid crystal composite of the liquid crystal device of the present invention comprises liquid crystal molecules and fine-particles, and the liquid crystal composite is optically isotropic when the voltage applied to the electrode layer is lower than a threshold value and undergoes optical transition due to change in the arrangement of the liquid crystal molecules when the applied voltage is not lower than the threshold value. Therefore, the liquid crystal device of the present invention shows a perfect dark state under cross polarizers, and a better or higher contrast ratio and displaying quality without requiring the alignment processes or alignment layers is obtained.

### Second Embodiment (Phase Separation LCD Panel)

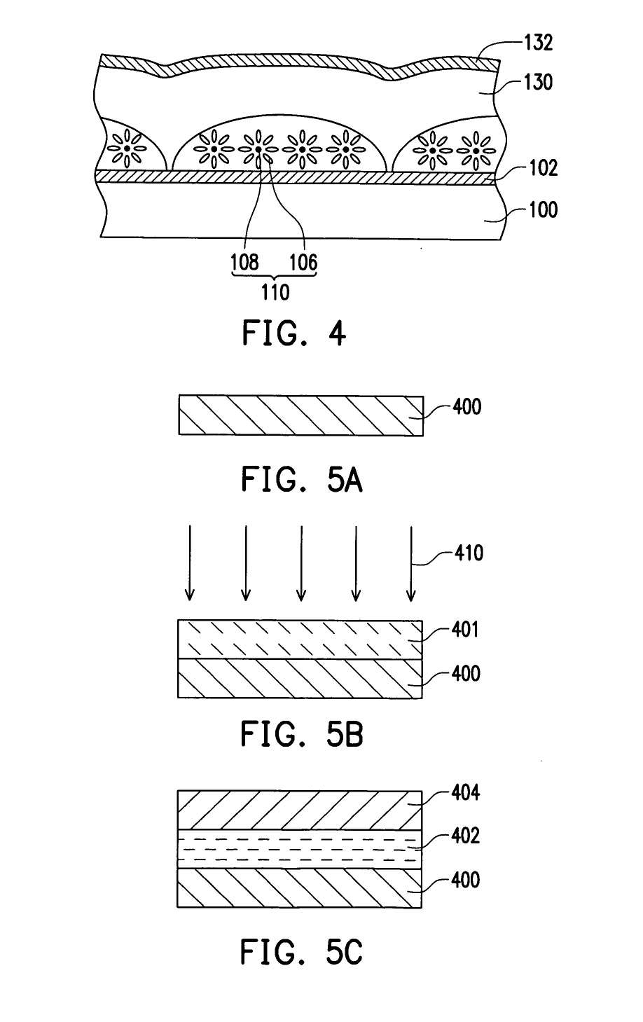

FIG. 4 is a cross-sectional view showing a phase separation liquid crystal device according to an embodiment of the present invention. As shown in FIG. 4, the phase separation liquid crystal device comprises a liquid crystal composite 110, a substrate 100 having an electrode layer 102 thereon, a counter electrode 132 and a covering layer 130. In particular, the liquid crystal composite 110 comprises liquid crystal molecules 106 and fine-particles 108. The substrate 100 having the electrode layer 102 is at a side of the liquid crystal composite 110 and confining the liquid crystal composite 110. The covering layer 130 is disposed adjacent to the liquid crystal composite 110 for covering the liquid crystal composite 110 at a side opposite to the substrate 100. The covering layer 130 is a polymer layer, for example. The counter electrode layer 132 is formed on an outside surface of the covering layer 130. As the drawing shown, the covering layer 130 confines the liquid crystal composite 110 into several cell units. Similarly, the phase separation liquid crystal device may further comprise other films, such as a color filter array, as described in the first embodiment.

In the phase separation liquid crystal device, the liquid crystal composite 110 includes liquid crystal molecules 106 and fine-particles 108. The alignment of liquid crystal molecules 106 is the same to that of the first embodiment shown in FIG. 3A and FIG. 3B. When the voltage applied to the electrode layer 102 is lower than a threshold value, the state of the liquid crystal composite is as shown in FIG. 3A. When the voltage applied to the electrode layer 102 is equal to or higher than the threshold value, the state of the liquid crystal composite is as shown in FIG. 3B.

In an embodiment, the fine-particles 108 have an amount of 1 to 20% by mass relative to the total mass of the fine-particles 108 and liquid crystal molecules 106. More preferable upper limit is 10% by mass and more preferable lower limit is 3% by mass. The liquid crystal composite 110 may contain additives such as an optically active substance, a dichroic dye or the like. The liquid crystal molecules 106 mentioned above are not particularly restricted if they are capable of exhibiting liquid crystallinity, and for example, nematic liquid crystal molecules are preferred. The dielectric anisotropy of the liquid crystal molecules 106 may be positive or negative but the use of liquid crystal molecules with a negative dielectric anisotropy is preferred.

The fine-particles 108 of the liquid crystal composite 110 in the present invention is not particularly restricted, and may be transparent or opaque. The fine-particles 108 may be organic solid particles, inorganic solid particles or the like. The organic solid particles can be made from styrenic or acrylic organic materials. For example, polystyrene beads, poly(methyl methacrylate) beads, poly(hydroxyethyl acrylate) beads or divinylbenzene beads. These may be crosslinked or uncrosslinked. In addition, the inorganic solid particles may be inorganic oxide. For example, silicon dioxide fine-particles or metal oxide fine-particles. Moreover, fine-particles comprising glass, silica, titania, alumina or other inorganic beads can also be preferably used. These fine-particles may be hydrophilic or hydrophobic. According to another embodiment of the present invention, the fine-particles 108 may include fullerene and/or carbon nanotubes. The fullerene mentioned above may be any of those having carbon atoms in a spherical shape. For example, the fullerene may be the one having a stable structure such that the number of carbon atoms is from 24 to 96. As such fullerene, the C60 spherical closed shell carbon molecule consisting of 60 carbon atoms, among others, can be mentioned. As the carbon nano-tube mentioned above, for example, a cylindrical nano-tube which is obtainable by circularizing the graphitic carbon-atom surface of a layer having a thickness of several atoms can be used. Moreover, the fine-particles 108 have an average particle diameter of not more than 0.2 μm. More preferred upper limit is 0.15 μm and more preferred lower limit is 0.001 μm.

In particular, the liquid crystal composite 110 of the liquid crystal device has fine-particles 108 therein. The fine-particles 108 may cause vertical alignment of liquid crystal molecules 106 on the particle surface. The vertical alignment of liquid crystal molecules 106 on the surface of the fine-particles 108 means the alignment of liquid crystal molecules 106 in the long axis direction on the surface of the fine-particles 108 to form a nematic orientation around the fine-particles. In this state, liquid crystal molecules 106 are aligned to surround the fine-particles 108.

The method of fabricating the phase separation liquid crystal device is as shown in FIG. 5A-5C. First, a substrate 400 is provided. Then, as shown in FIG. 5B, a stratified-phase-separable composition film 401 is coated on the substrate 400. The composition film 401 includes a liquid crystal material, which comprising liquid crystal molecules and fine-particles, and at least a monomer. The composition film 401 can be formed by blade coating process at room temperature. After that, the composition film 401 is exposed to a UV light 410. Upon exposure to UV light 410, the light intensity being highest near the top of the composition film 401, polymerization selectivity occurs in the near the film/air interface. The polymer formed by the UV exposure is not miscible with the liquid crystal material and thus phase separates from the liquid crystal material. Therefore, a polymer layer 404 is formed on the top of the liquid crystal material 402, as shown in FIG. 5C. The more detailed methods of phase separation can be found in the prior art, such as the methods disclosed in WO 0248783 and U.S. Pat. No. 6,818,152.

In the embodiment, the liquid crystal composite of the phase separation liquid crystal device comprises liquid crystal molecules and fine-particles, and the liquid crystal composite is optically isotropic when the voltage applied to the electrode layer is lower than a threshold value and undergoes optical transition due to change in the arrangement of the liquid crystal molecules when the applied voltage is not lower than the threshold value. Therefore, the liquid crystal device of the present invention shows a perfect dark state under cross polarizers, and a better or higher contrast ratio and displaying quality without requiring the alignment processes or alignment layers is obtained.

### Third Embodiment (Droplet Encapsulated LCD Panel)

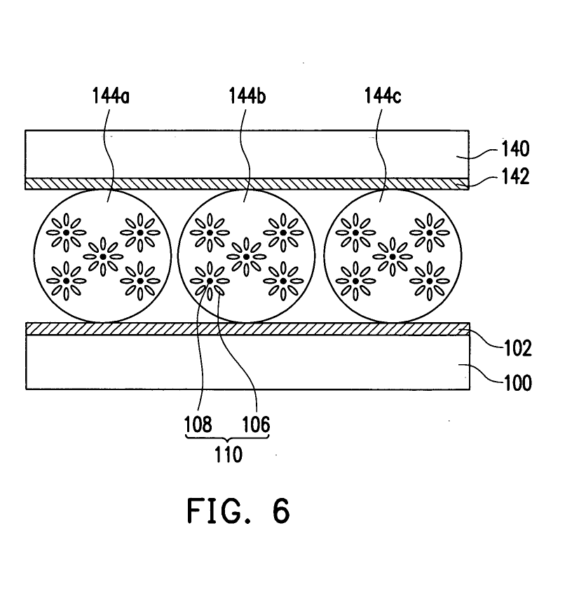

FIG. 6 is a cross-sectional view showing a droplet encapsulated liquid crystal device according to an embodiment of the present invention. As shown in FIG. 6, the droplet encapsulated liquid crystal device comprises a plurality of droplets of liquid crystal composite 144a, 144b, 144c, a substrate 100 having an electrode layer 102 thereon and a covering layer 140. The covering layer 140 may also be a counter substrate. According to an embodiment of the present invention, a counter electrode 142 is further formed between the covering layer (or substrate) 140 and the liquid crystal composite 110.

In the droplet encapsulated liquid crystal device, the liquid crystal composite 110 in each droplet 144a or 144b or 144c includes liquid crystal molecules 106 and fine-particles 108. The alignment of liquid crystal molecules 106 is the same to that of the first embodiment shown in FIG. 3A and FIG. 3B. That is, when the voltage applied to the electrode layer 102 is lower than a threshold value, the state of the liquid crystal composite is as shown in FIG. 3A. When the voltage applied to the electrode layer 102 is equal to or higher than the threshold value, the state of the liquid crystal composite is as shown in FIG. 3B.

In an embodiment, the fine-particles 108 have an amount of 1 to 20% by mass relative to the total mass of the fine-particles 108 and liquid crystal molecules 106. More preferable upper limit is 10% by mass and more preferable lower limit is 3% by mass. The liquid crystal composite 110 may contain additives such as an optically active substance, a dichroic dye or the like. The liquid crystal molecules 106 mentioned above are not particularly restricted if they are capable of exhibiting liquid crystallinity, and for example, nematic liquid crystal molecules are preferred. The dielectric anisotropy of the liquid crystal molecules 106 may be positive or negative but the use of liquid crystal molecules with a negative dielectric anisotropy is preferred.

The fine-particles 108 of the liquid crystal composite 110 in the present invention is not particularly restricted, and may be transparent or opaque. The fine-particles 108 may be organic solid particles, inorganic solid particles or the like. The organic solid particles can be made from styrenic or acrylic organic materials. For example, polystyrene beads, poly(methyl methacrylate) beads, poly(hydroxyethyl acrylate) beads or divinylbenzene beads. These may be crosslinked or uncrosslinked. In addition, the inorganic solid particles may be inorganic oxide. For example, silicon dioxide fine-particles or metal oxide fine-particles. Moreover, fine-particles comprising glass, silica, titania, alumina or other inorganic beads can also be preferably used. These fine-particles may be hydrophilic or hydrophobic. According to another embodiment of the present invention, the fine-particles 108 may include fullerene and/or carbon nanotubes. The fullerene mentioned above may be any of those having carbon atoms in a spherical shape. For example, the fullerene may be the one having a stable structure such that the number of carbon atoms is from 24 to 96. As such fullerene, the C60 spherical closed shell carbon molecule consisting of 60 carbon atoms, among others, can be mentioned. As the carbon nano-tube mentioned above, for example, a cylindrical nano-tube which is obtainable by circularizing the graphitic carbon-atom surface of a layer having a thickness of several atoms can be used. Moreover, the fine-particles 108 have an average particle diameter of not more than 0.2 μm. More preferred upper limit is 0.15 μm and more preferred lower limit is 0.001 μm.

In particular, the liquid crystal composite 110 of the liquid crystal device has fine-particles 108 therein. The fine-particles 108 may cause vertical alignment of liquid crystal molecules 106 on the particle surface. The vertical alignment of liquid crystal molecules 106 on the surface of the fine-particles 108 means the alignment of liquid crystal molecules 106 in the long axis direction on the surface of the fine-particles 108 to form a nematic orientation around the fine-particles. In this state, liquid crystal molecules 106 are aligned to surround the fine-particles 108.

A method for producing the droplets of liquid crystal composite includes the steps of dispersing a liquid crystal molecules and fine-particles in a dispersion medium composed mainly of water to prepare an oil-in-water type emulsion, for example. The method of forming the droplets for the droplet encapsulated liquid crystal device can be any suitable method in the prior art, such as the emulsion methods disclosed in U.S. Pat. No. 5,183,585, U.S. Pat. No. 4,688,900, and U.S. Pat. No. 6,108,062. No matter what method is used to fabricate the droplet encapsulated liquid crystal liquid crystal device, each droplet comprises at least liquid crystal molecules and fine-particles. After droplets are fabricated, they can be applied on a substrate to form a display directly by a process, such as coating. Therefore, it is a roll-to-roll compatible process with low manufacture cost.

Such droplet encapsulated liquid crystal composite is optically isotropic when the voltage applied to the electrode layer is lower than a threshold value and undergoes optical transition due to change in the arrangement of the liquid crystal molecules when the applied voltage is not lower than the threshold value. Therefore, the liquid crystal device of the present invention shows a perfect dark state under cross polarizers, and a better or higher contrast ratio and displaying quality without requiring the alignment processes or alignment layers is obtained.

### Forth Embodiment (Tube-Encapsulate Liquid Crystal Device)

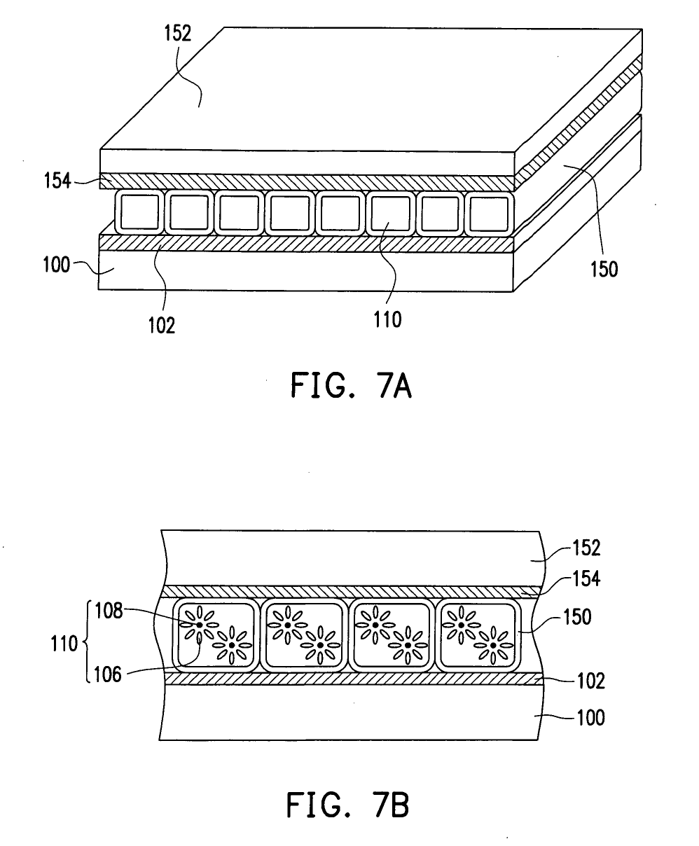

FIG. 7A is diagram showing a tube-encapsulated liquid crystal device according to an embodiment of the present invention. FIG. 7B is a cross-sectional view showing the tube-encapsulated liquid crystal device. Please refer to FIG. 7A and FIG. 7B, the liquid crystal device comprises a first substrate 100 having an electrode layer 102, a second substrate 152 disposed opposite to the first substrate 100, a plurality of tubes 150 disposed parallel to each other between the first and second substrates 100, 152, a counter electrode 154 and a liquid crystal composite 110 filled in the tubes 152. These tubes 150 are transparent or light transmissive.

In particular, the liquid crystal composite 110 includes liquid crystal molecules 106 and fine-particles 108. The alignment of liquid crystal molecules 106 is the same to that of the first embodiment shown in FIG. 3A and FIG. 3B. In other words, when the voltage applied to the electrode layer 102 is lower than a threshold value, the state of the liquid crystal composite is as shown in FIG. 3A. When the voltage applied to the electrode layer 102 is equal to or higher than the threshold value, the state of the liquid crystal composite is as shown in FIG. 3B.

In an embodiment, the fine-particles 108 have an amount of 1 to 20% by mass relative to the total mass of the fine-particles 108 and liquid crystal molecules 106. More preferable upper limit is 10% by mass and more preferable lower limit is 3% by mass. The liquid crystal composite 110 may contain additives such as an optically active substance, a dichroic dye or the like. The liquid crystal molecules 106 mentioned above are not particularly restricted if they are capable of exhibiting liquid crystallinity, and for example, nematic liquid crystal molecules are preferred. The dielectric anisotropy of the liquid crystal molecules 106 may be positive or negative but the use of liquid crystal molecules with a negative dielectric anisotropy is preferred.

The fine-particles 108 of the liquid crystal composite 110 in the present invention is not particularly restricted, and may be transparent or opaque. The fine-particles 108 may be organic solid particles, inorganic solid particles or the like. The organic solid particles can be made from styrenic or acrylic organic materials. For example, polystyrene beads, poly(methyl methacrylate) beads, poly(hydroxyethyl acrylate) beads or divinylbenzene beads. These may be crosslinked or uncrosslinked. In addition, the inorganic solid particles may be inorganic oxide. For example, silicon dioxide fine-particles or metal oxide fine-particles. Moreover, fine-particles comprising glass, silica, titania, alumina or other inorganic beads can also be preferably used. These fine-particles may be hydrophilic or hydrophobic. According to another embodiment of the present invention, the fine-particles 108 may include fullerene and/or carbon nanotubes. The fullerene mentioned above may be any of those having carbon atoms in a spherical shape. For example, the fullerene may be the one having a stable structure such that the number of carbon atoms is from 24 to 96. As such fullerene, the C60 spherical closed shell carbon molecule consisting of 60 carbon atoms, among others, can be mentioned. As the carbon nano-tube mentioned above, for example, a cylindrical nano-tube which is obtainable by circularizing the graphitic carbon-atom surface of a layer having a thickness of several atoms can be used. Moreover, the fine-particles 108 have an average particle diameter of not more than 0.2 μm. More preferred upper limit is 0.15 μm and more preferred lower limit is 0.001 μm.

In particular, the liquid crystal composite 110 of the liquid crystal device has fine-particles 108 therein. The fine-particles 108 may cause vertical alignment of liquid crystal molecules 106 on the particle surface. The vertical alignment of liquid crystal molecules 106 on the surface of the fine-particles 108 means the alignment of liquid crystal molecules 106 in the long axis direction on the surface of the fine-particles 108 to form a nematic orientation around the fine-particles. In this state, liquid crystal molecules 106 are aligned to surround the fine-particles 108.

The method of forming the liquid crystal devices with tubes can be any suitable method in the prior art, such as the methods disclosed in U.S. Pat. No. 6,876,476. No matter what method is used to fabricate the liquid crystal devices with tubes, the liquid crystal composite comprises liquid crystal molecules and fine-particles. Such that the liquid crystal composite is optically isotropic when the voltage applied to the electrode layer is lower than a threshold value and undergoes optical transition due to change in the arrangement of the liquid crystal molecules when the applied voltage is not lower than the threshold value. Therefore, the liquid crystal device of the present invention shows a perfect dark state under cross polarizers, and a better or higher contrast ratio and displaying quality without requiring the alignment processes or alignment layers is obtained.

### Wide Viewing Angle Liquid Crystal Devices

In the present invention, the liquid crystal devices described in the first, second, third and forth embodiments have a better or high contrast ratio and displaying quality without requiring any alignment processes and alignment layers. If wide viewing angle for these liquid crystal devices is required, additional design will be further added in these liquid crystal devices. A detail description is as following paragraphs.

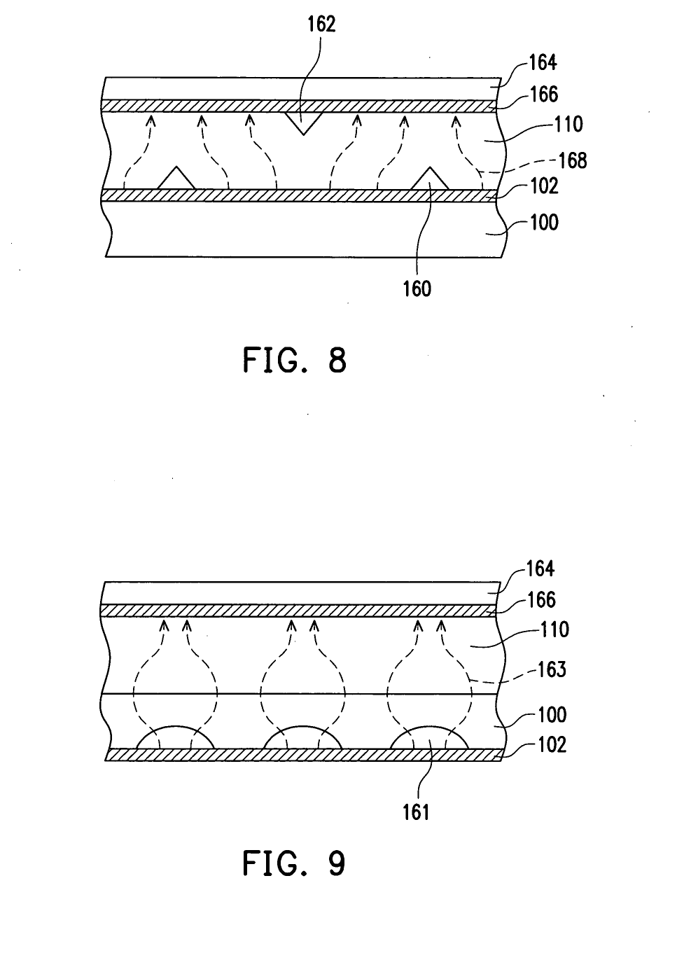

In order to achieve the wide viewing angle requirement, the liquid crystal device may further comprise a plurality of protrusions. For example, as shown in FIG. 8, the liquid crystal device having the liquid crystal composite 110 comprising liquid crystal molecules and fine-particles as mentioned above further comprise protrusions 160 over the substrate 100. According to another embodiment, the liquid crystal device comprises additional protrusions 162 disposed on the covering layer (or substrate) 164 opposite to the protrusions 160. When a driving voltage is applied, the electric field 162 formed between the two electrode layer 102, 166 may be distorted because of the protrusions 160 and/or protrusions 162 formation. In the meanwhile, the liquid crystal molecules may align perpendicular to the electric field 168, and thus the purpose of the wide viewing angle for the liquid crystal device can be achieved. It should be noted the protrusions 160/162 can be formed in the micro-cup LCD (described in the first embodiment), phase separation LCD (described in the second embodiment), droplet encapsulated LCD (described in the third embodiment) and tube-encapsulated LCD (described in the forth embodiment).

According to another embodiment of the present invention, as shown in FIG. 9, the liquid crystal device comprises a plurality of micro-cavities 161 in the substrate 100 for the objective of wide viewing angle, and the electrode later 102 is formed on the bottom surface of the substrate 100. Similarly, when a driving voltage is applied, the electric field 163 formed between the two electrode layer 102, 166 may be distorted because of the micro-cavities 161 formation. In the meanwhile, the liquid crystal molecules in the liquid crystal composite 110 may align perpendicular to the electric field 163, and thus the purpose of the wide viewing for the liquid crystal liquid crystal device can be achieved. The micro-cavities 161 in the substrate 100 can be formed by molding process, for example, the method disclosing in the reference of Y. T. Kim, C. Jeong, S. W. Lee, S. D. Lee, “Technology of Spontaneously Forming Multidomains for Wideviewing Angle LCDs”, SID 05 DIGEST, pp 638-641 (2005). Similary, the micro-cavities 161 can be formed in the micro-cup LCD panel (described in the first embodiment), phase separation LCD panel (described in the second embodiment), droplet encapsulated LCD panel (described in the third embodiment) and tube-encapsulated LCD panel (described in the forth embodiment).

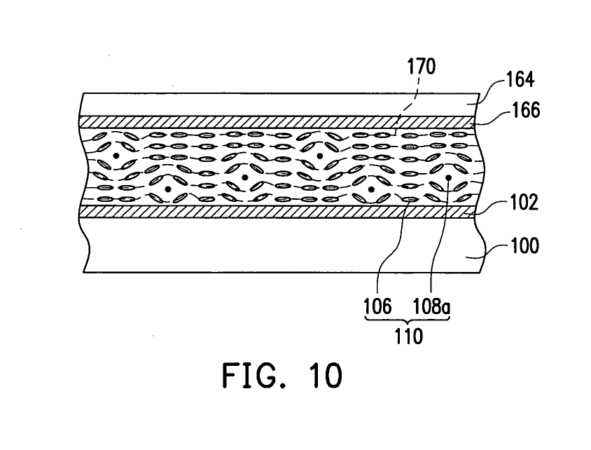

According to another embodiment of the present invention, as shown in FIG. 10, the fine-particles added in the liquid crystal composite are conductive, such as metal particles. If the fine-particles are conductive fine-particles, the liquid crystal device can also achieve wide viewing angle without forming protrusions or micro-cavities. As shown in FIG. 10, the fine-particles 108a of the liquid crystal composite 110 are conductive so that the equal potential lines 170 near the conductive fine-particles 108a are distorted when a driving voltage is applied on the two electrode layer 102, 166. As a result, the liquid crystal molecules 106 arranged parallel to the potential lines 170 are multi-directional aligned. The objective of wide viewing angle can be achieved by using the liquid crystal composite 110 comprising the liquid crystal molecules 106 and conductive fine-particles 108a. Similarity, the liquid crystal composite 110 including liquid crystal molecules 106 and conductive fine-particles 108a can be used in the micro-cup LCD panel (described in the first embodiment), phase separation LCD panel (described in the second embodiment), droplet encapsulated LCD panel (described in the third embodiment) and tube-encapsulated-LCD panel (described in the forth embodiment).

### Roll-to-Roll Manufacturing Process

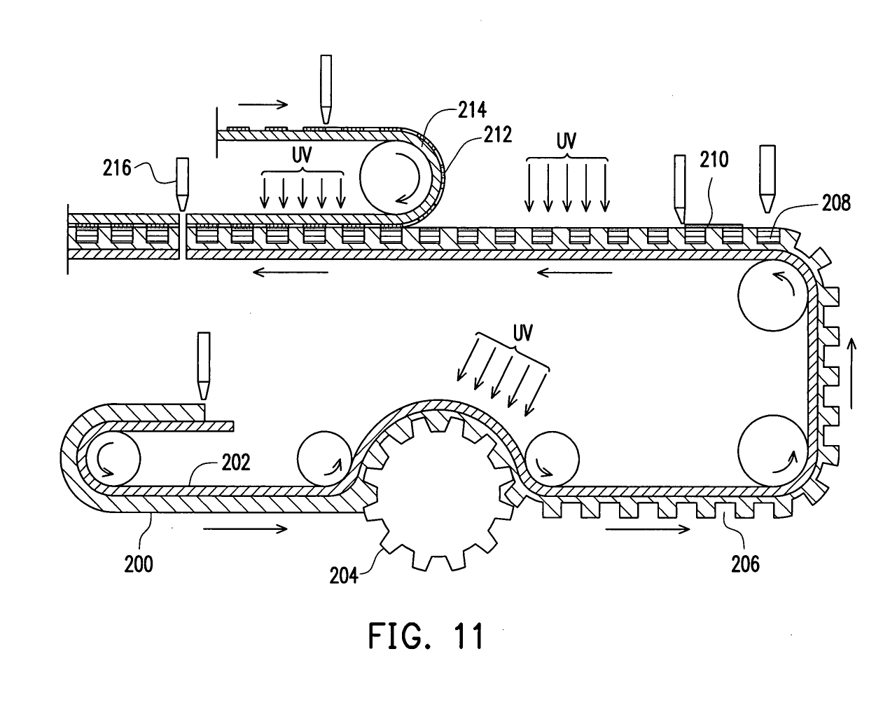

The liquid crystal devices described in the first, second, third and forth embodiments can be formed by a continuous roll-to-roll process. As shown in FIG. 11, the continuous roll-to-roll process is suitable for the micro-cup LCD panel described in the first embodiment. First, an electrode layer 202 is coated on a substrate 200. In an embodiment, a layer 200 of thermoplastic or thermoset precursor may be optionally coated with a solvent on a conductor film 202. The solvent, if present, readily evaporates. Then, the thermoplastic or thermoset layer 200 is embossed at a temperature higher than the glass transition temperature of the thermoplastic or thermoset layer by a pre-patterned male mold 204. The mold 204 is released from the thermoplastic or thermoset layer 200 preferably during or after it is hardened by proper means, and then an array of microcups 206 is formed. Thereafter, the thus-formed array of microcups 206 are filled with a liquid crystal composite 208 comprising liquid crystal molecules and fine-particles as above mentioned. The microcups 206 filled with the liquid crystal composite 208 are sealed with a sealant 210. According to an embodiment of the present invention, the sealant 210 is hardened or solidified by a UV radiation process. Next, the sealed array micro-cups filled with the liquid crystal composite 208 are laminated with a conductor film 214 pre-coated with an adhesive layer 212 which may be a pressure sensitive adhesive, a hot melt adhesive, a heat, moisture, or radiation curable adhesive. The laminate adhesive 212 may be hardened by heat or radiation such as UV through the top conductor film 214. Thereafter, the laminated product may be cut by a cutting mean 216 to appropriate size for integrating to device.

According to an embodiment of the present invention, the liquid crystal device comprises protrusions (as shown in FIG. 8) or micro-cavities (as shown in FIG. 9), the protrusions or micro-cavities may be formed before the layer 200 is embossed by the mold 204 as shown in FIG. 11. In other words, the protrusions or micro-cavities have been formed on/in the layer 200 previous to the continuous roll-to-roll process. In another embodiment, the protrusions or micro-cavities can be formed during the embossing step of FIG. 11 as long as the mold is modified. In details, the pre-patterned male mold 204 further has protrusion patterns or micro-cavity patterns thereon, such that the protrusions or micro-cavities can be formed together with micro-cup during the embossing step.

For the phase separation LCD panel (described in the second embodiment), droplet encapsulated LCD panel (described in the third embodiment) and tube-encapsulated-LCD panel, modified roll-to-roll processes can be used for manufacturing them. For the phase separation LCD, a mixture of liquid crystal molecules and monomers can be coated on a substrate and photo-induced phase separation can be applied thereafter. For droplet encapsulated LCD and tube-encapsulated LCD, the LC and fine particles filled droplets and tubing can be directly coating or weaving on a substrate to form a LCD. In such liquid crystal devices, the phase separation LCD panel, droplet encapsulated LCD panel and tube-LCD panel, the micro-cup forming step is not needed, and thus the mold 204 will be modified for these liquid crystal devices.

The liquid crystal devices and method of manufacturing the same have advantages as following:

1. The liquid crystal composite of the liquid crystal device of the present invention comprises liquid crystal molecules and fine-particles, and the liquid crystal composite is optically isotropic when the voltage applied to the electrode layer is lower than a threshold value and undergoes optical transition due to change in the arrangement of the liquid crystal molecules when the applied voltage is equal to or higher than the threshold value. Therefore, the liquid crystal device of the present invention shows a perfect dark state under cross polarizers, and a better or higher contrast ratio and displaying quality without requiring the alignment processes or alignment layers is obtained.

2. In the present invention, the contrast ratio and displaying quality of the liquid crystal device are improved by adding fine-particles into the liquid crystal composite. The manufacturing process is not complicated and the manufacturing process is adapted to the roll-to-roll compatible process.

3. Since the liquid crystal device has better or higher contrast ratio and displaying quality by just adding fine-particles into the liquid crystal composite, the roll-to-roll compatible process is easy to apply to various mode and scale up with low cost.

4. In the liquid crystal devices of the present invention, the protrusions or micro-cavities may be further formed for the purpose of wide viewing angle. In particular, the step of forming protrusions or micro-cavities can be easily integrated into the roll-to-roll compatible process.

5. If the fine-particles added in the liquid crystal composite are conductive, the liquid crystal device can also achieve wide viewing angle without forming protrusions or micro-cavities.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal device, comprising:
a substrate having an electrode layer and a plurality of micro-cups thereon;
a liquid crystal composite filled in the micro-cups, wherein the liquid crystal composite comprises liquid crystal molecules and fine-particles, and is optically isotropic when a voltage applied to the electrode layer is lower than a threshold value and undergoes optical transition due to change in an arrangement of the liquid crystal molecules when the applied voltage is equal to or higher than the threshold value; and
a covering component having a counter electrode layer thereon disposed over the micro-cups.

2. The liquid crystal device according to claim 1, wherein the fine-particles have an average particle diameter of not more than 0.2 μm.

3. The liquid crystal device according to claim 1, wherein the fine-particles comprise conductive fine-particles.

4. The liquid crystal device according to claim 1, further comprising a plurality of protrusions over the substrate.

5. The liquid crystal device according to claim 1, wherein the substrate has a plurality of micro-cavities therein.

6. A liquid crystal device, comprising:
a liquid crystal composite, wherein the liquid crystal composite comprises liquid crystal molecules and fine-particles, and is optically isotropic when a voltage applied to the electrode layer is lower than a threshold value and undergoes optical transition due to change in an arrangement of the liquid crystal molecules when the applied voltage is equal to or higher than the threshold value;
a substrate having an electrode layer thereon disposed at a side of the liquid crystal composite and confining the liquid crystal composite; and
a covering layer having a counter electrode layer thereon disposed adjacent to the liquid crystal composite for covering the liquid crystal composite at a side opposite to the substrate.

7. The liquid crystal device according to claim 6, wherein the liquid crystal composite is encapsulated in a plurality of regions, and the counter electrode is disposed between the covering layer and the liquid crystal composite.

8. The liquid crystal device according to claim 7, wherein the covering layer is a counter substrate.

9. The liquid crystal device according to claim 6, wherein the covering layer is a polymer layer, and the counter electrode is disposed on a outside surface of the polymer layer.

10. The liquid crystal device according to claim 6, wherein the fine-particles have an average particle diameter of not more than 0.2 μm.

11. The liquid crystal device according to claim 6, wherein the fine-particles comprises conductive fine-particles.

12. The liquid crystal device according to claim 6, further comprising a plurality of protrusions over the substrate.

13. The liquid crystal device according to claim 6, wherein the substrate has a plurality of micro-cavities therein.

14. A liquid crystal device, comprising:
a first substrate having an electrode layer;
a second substrate disposed opposite to the first substrate;
a plurality of tubes disposed parallel to each other between the first and second substrates; and
a liquid crystal composite filled in the tubes, wherein the liquid crystal composite comprises liquid crystal molecules and fine-particles, and is optically isotropic when a voltage applied to the electrode layer is lower than a threshold value and undergoes optical transition due to change in an arrangement of the liquid crystal molecules when the applied voltage is equal to or higher than the threshold value.

15. The liquid crystal device according to claim 14, wherein the fine-particles have an average particle diameter of not more than 0.2 μm.

16. The liquid crystal device according to claim 14, wherein the fine-particles comprise conductive fine-particles.

17. The liquid crystal device according to claim 14, further comprising a plurality of protrusions over the substrate.

18. The liquid crystal device according to claim 14, wherein the substrate has a plurality of micro-cavities therein.

19. A method of forming a liquid crystal device, comprising:
providing a substrate having an electrode layer thereon;
forming a liquid crystal composite over the substrate, wherein the liquid crystal composite comprises liquid crystal molecules and fine-particles, and is optically isotropic when a voltage applied to the electrode layer is lower than a threshold value and undergoes optical transition due to change in an arrangement of the liquid crystal molecules when the applied voltage is equal to or higher than the threshold value; and
forming a covering component over the liquid crystal composite,
wherein the steps of providing the substrate, forming the liquid crystal composite and forming the covering component are performed with a roll-to-roll continuous process.

20. The method according to claim 19, further comprising forming a plurality micro-cups on the substrate before the liquid crystal composite is formed on the substrate.

21. The method according to claim 19, wherein the step of forming the liquid crystal composite comprising:
forming a plurality of droplets with the liquid crystal composite encapsulated therein; and
coating the droplets of the liquid crystal composite over the substrate.

22. The method according to claim 19, wherein the steps of forming the liquid crystal composite and the covering component comprising:
forming a composition film including the liquid crystal composite and at least a monomer over the substrate;
performing an exposure step to the composition film so that a polymerization selectivity occurs, and then a polymer layer is formed on the top of the liquid crystal composite.

23. The method according to claim 19, wherein the step of forming the liquid crystal composite comprising:
forming a plurality of tubes with the liquid crystal composite therein; and
arranging the tubes with the liquid crystal composite over the substrate.

24. The method according to claim 19, further comprising forming a plurality of protrusions over the substrate before the liquid crystal composite is formed over the substrate.

25. The method according to claim 19, further comprising forming a plurality of micro-cavities in the substrate before the liquid crystal composite is formed over the substrate.

26. The method according to claim 19, wherein the fine-particles comprise conductive fine-particles.
